(19) United States
(12) Patent Application Publication
(10) Pub. No.: US 2008/0063326 A1
(43) Pub. Date: Mar. 13, 2008

(54) Linear motion guide apparatus having ball retaining device

(75) Inventor: Jen Sheng Chen, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/516,869

(22) Filed: Sep. 7, 2006

(51) Int. Cl. F16C 29/06

(52) U.S. Cl. 384/45

(57) ABSTRACT

A linear motion guide device includes a slider slidably attached onto a guide rail, two end caps attached to the slider and each having a chamber formed in such as a frame, and two shanks each having an end segment for engaging into the chambers of the end caps from a notch of the frame, the shanks are engaged with a ball bearing device for retaining the ball bearing device in the slider. An anchoring device may anchor the end segments of the shanks to the end caps and may detachably secure the shanks to the end caps for allowing the shanks to be easily and readily attached to the end caps without distorting or deforming the shanks.

### BACKGROUND OF THE INVENTION

1. Field of the Invention

The present invention relates to a linear motion guide apparatus, and more particularly to a linear motion guide apparatus including a ball retaining device designed and arranged to be easily and readily attached to the linear motion guide apparatus without distorting or deforming the configuration or the structure of the ball retaining device.

2. Description of the Prior Art

Typical linear motion guide devices comprise a slider or slide block slidably attached onto a guide rail, and a ball bearing device or a number of balls slidably disposed between the slider and the guide rail for improving or facilitating the sliding movement between the slider and the guide rail and thus for allowing the slider and the guide rail to be smoothly or swiftly moved relative to each other.

For example, U.S. Pat. No. 5,308,166 to Osawa discloses one of the typical linear motion guide devices also comprising a slider or slide block slidably attached onto a guide rail, and a ball bearing device or a number of balls disposed between the slider and the guide rail, and a ball retainer disposed in the slide block and having one or more ball holding grooves formed therein for holding or engaging with the balls or ball bearing device and for stably anchoring and positioning the balls to the slide block and the guide rail and for preventing the balls from being disengaged from the slide block and the guide rail.

For allowing the balls to be engaged into the ball holding grooves that are formed or defined between the slide block and the guide rail, the ball retainer is required to have two work holes formed therein for engaging with a tool, such as a snap ring which may distort or deform the ball retainer in order to slightly increase the width or the space of the ball holding grooves and thus to allow the balls to be suitably or easily engaged into the ball holding grooves that are formed or defined between the slide block and the guide rail.

However, when the ball retainer is selectively made of resilient or softer materials for allowing the ball retainer to be suitably distorted or deformed, the resilient or softer ball retainer may not be used to suitably engage with the balls such that the balls may not be suitably anchored and retained to the slide block and the guide rail with the ball retainer.

On the contrary, when the ball retainer is selectively made of stronger or stiffer or harder materials for allowing the ball retainer to suitably engage with the balls and to stably anchor and retain the balls to the slide block and the guide rail, the ball retainer may not be easily distorted or deformed with the snap ring such that the balls may not be suitably or easily engaged into the ball holding grooves that are formed or defined between the slide block and the guide rail.

The present invention has arisen to mitigate and/or obviate the afore-described disadvantages of the conventional linear motion guide devices.

### SUMMARY OF THE INVENTION

The primary objective of the present invention is to provide a linear motion guide apparatus including a ball retaining device designed and arranged to be easily and quickly and readily attached or coupled to the linear motion guide apparatus without distorting or deforming the configuration or the structure of the ball retaining device.

In accordance with one aspect of the invention, there is provided a linear motion guide apparatus comprising a guide rail, a slider slidably attached onto the guide rail for moving along the guide rail, the slider including two side grooves formed therein for slidably receiving a ball bearing device, two end caps attached to the slider, the end caps each including a chamber formed therein, and a ball retaining device including two shanks each having an end segment for engaging into the chambers of the end caps, the shanks being engageable with the ball bearing device for stably anchoring and retaining the ball bearing device in the grooves of the slider, and an anchoring device for anchoring the end segments of the shanks to the end caps and to detachably secure the shanks of the ball retaining device to the end caps.

The end caps each include a peripheral frame extended therefrom and having the chamber formed in the peripheral frame for receiving the end segments of the shanks. The end segments of the shanks include a narrower outer peripheral contour than that of the shanks for forming an outer peripheral shoulder between the end segment and the shank.

The end caps each include a reduced end portion formed therein and communicating with the chamber of the end cap, and the end segments of the shanks each include a reduced outer flange provided thereon for engaging with the reduced end portions of the end caps.

The end caps each include a cavity formed therein and communicating with the chamber of the end cap, and the anchoring device includes a catch extended from each of the end segments of the shanks for engaging with the cavity of the end cap and thus for detachably securing the end segments of the shanks to the end caps or the slider.

The end caps each include a peripheral frame extended therefrom and having the chamber formed in the peripheral frame for receiving the end segments of the shanks. The end caps each include a peripheral frame extended therefrom and having the chamber formed in the peripheral frame, and a notch formed in the peripheral frame and communicating with the chamber of the peripheral frame for forming two arms and two spaces in the peripheral frame.

The end segments of the shanks include a width or length no greater than the notches of the end caps for allowing the end segments of the shanks to be engaged through the notches and then into the spaces and the chamber of the peripheral frames of the end caps. The catches preferably include a rounded contour for facilitating the engagement of the catches into the cavities of the end caps.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a linear motion guide apparatus in accordance with the present invention;

FIG. 2 is a cross sectional view of the linear motion guide apparatus taken along lines 2-2 of FIG. 1;

FIG. 3 is a partial exploded view of the linear motion guide apparatus;

FIG. 4 is another partial exploded view illustrating a ball retaining device for the linear motion guide apparatus;

FIG. 5 is an enlarged perspective view illustrating an end cap of the linear motion guide apparatus;

FIG. 6 is a plan schematic view or partial cross sectional view illustrating the assembling of the ball retaining device to the end cap of the linear motion guide apparatus.

FIG. 7 is a partial plan and exploded view also illustrating the assembling of the ball retaining device to the end cap of the linear motion guide apparatus.

FIG. 8 is a further partial exploded view illustrating the assembling of the ball retaining device to the linear motion guide apparatus.

FIG. 9 is a plan schematic view or partial cross sectional view similar to FIG. 6, illustrating the other arrangement of the linear motion guide apparatus;

FIG. 10 is a partial plan and exploded view illustrating the assembling of the ball retaining device to the end cap of the linear motion guide apparatus as that shown in FIG. 9; and

FIG. 11 is a partial exploded view illustrating the ball retaining device for the linear motion guide apparatus as that shown in FIGS. 9-10.

### DETAILED DESCRIPTION OF THE PREFERRED EMBODIMENT

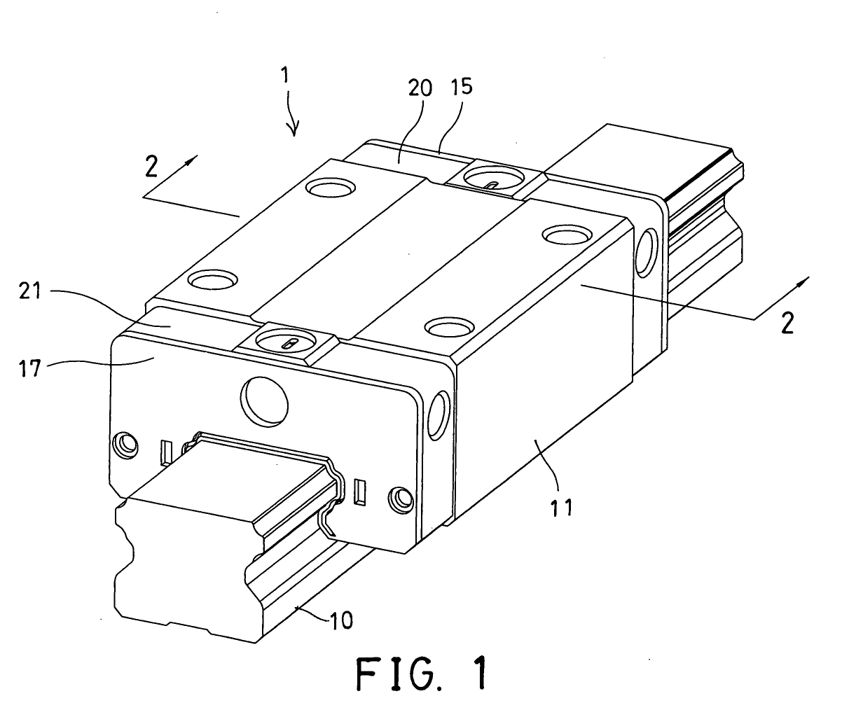

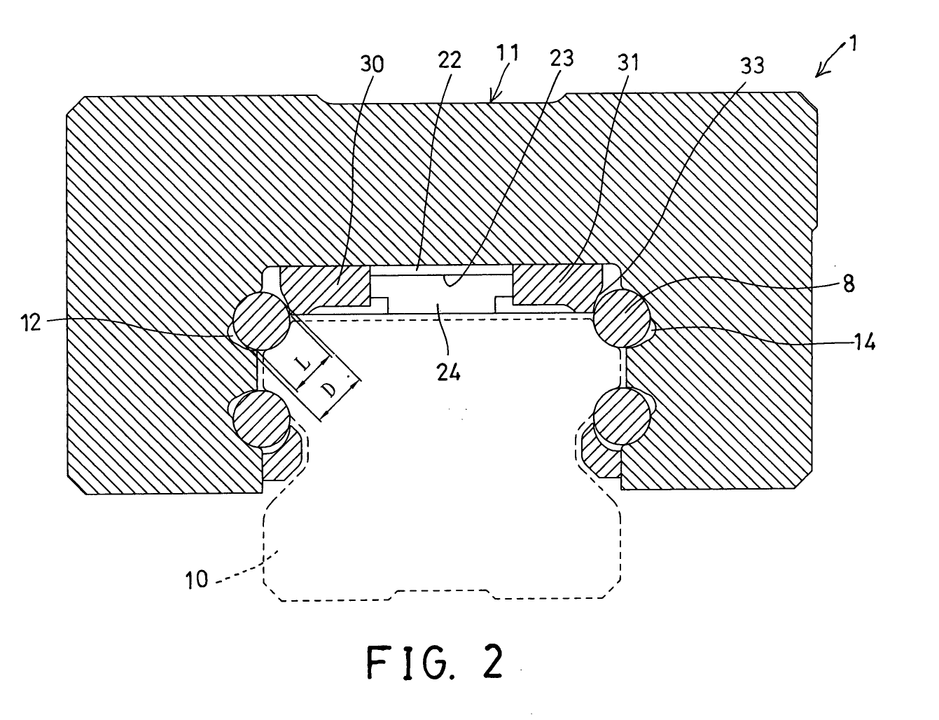

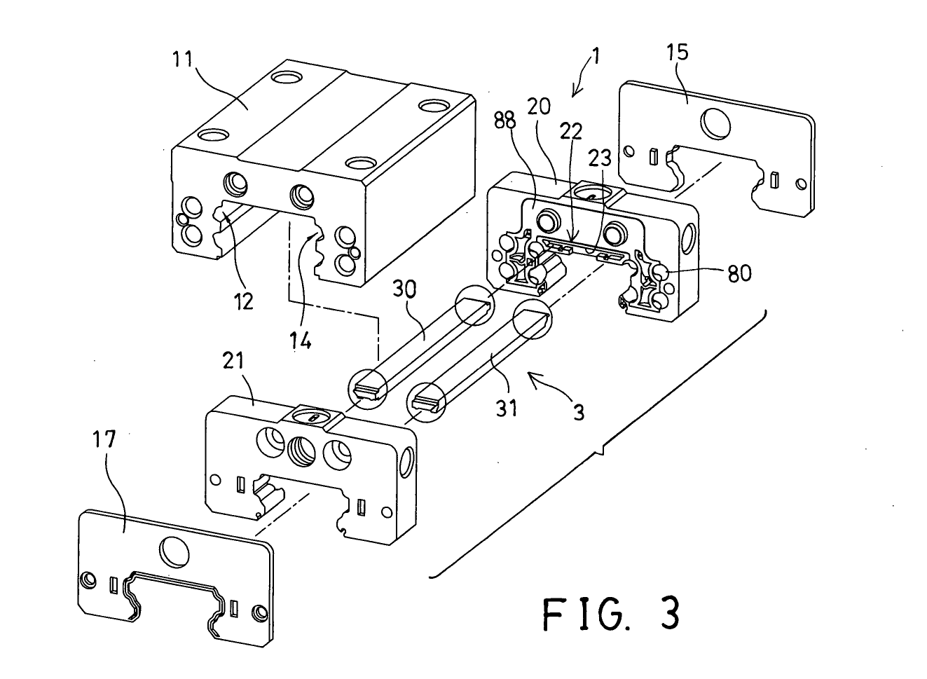

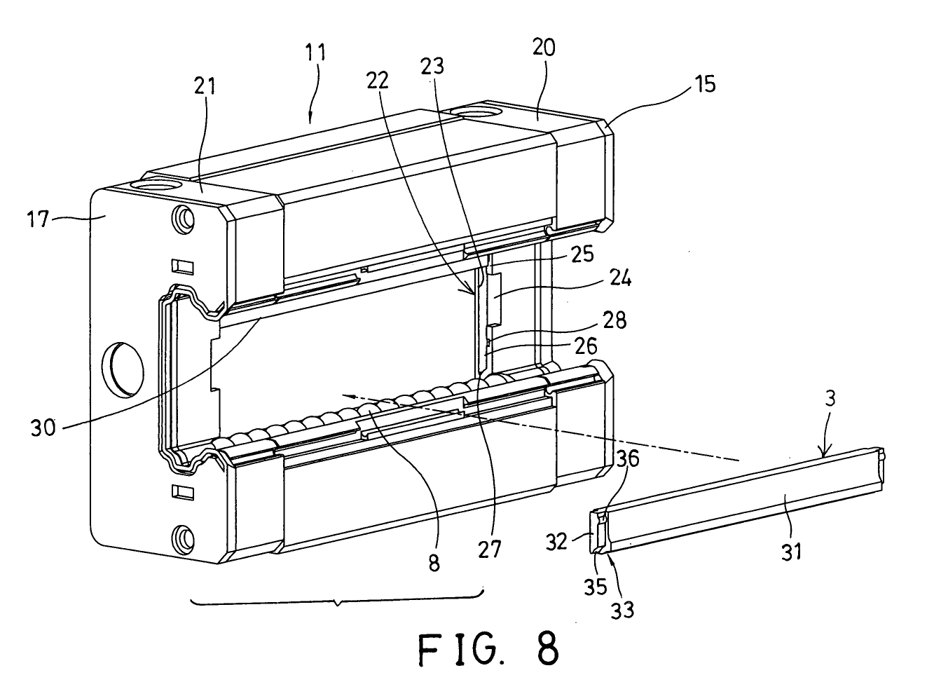

Referring to the drawings, and initially to FIGS. 1-3, a linear motion guide apparatus 1 in accordance with the present invention comprises a guide rail 10, and a slide block or a slider 11 slidably attached onto the guide rail 10 and arranged to be moved along the guide rail 10, and a ball bearing device or a number of balls 8 (FIGS. 2, 8) disposed between the slider 11 and the guide rail 10 for improving or for facilitating the sliding movement between the slider 11 and the guide rail 10 and thus for allowing the slider 11 and the guide rail 10 to be smoothly moved relative to each other. The slider 11 includes two or more side grooves 12, 14 formed therein (FIGS. 2, 3) for slidably receiving the balls or ball bearing device 8.

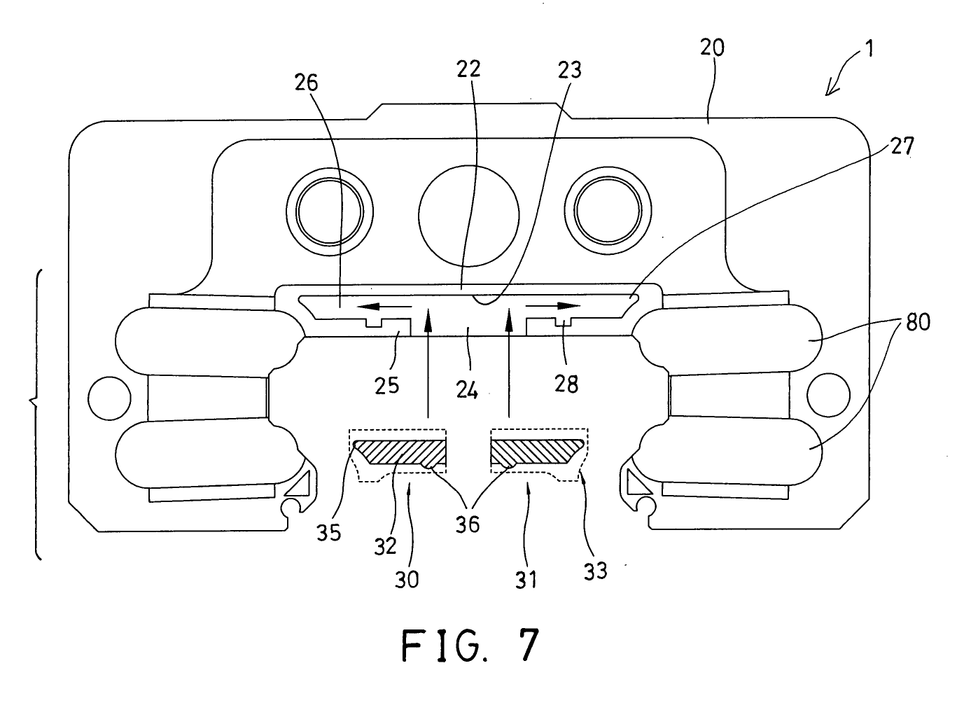

The linear motion guide apparatus 1 further includes two end caps 20, 21 disposed on or attached to the two sides or end portions or outer portions of the slider 11 (FIGS. 1, 3, 8), and two dust caps or wipers 15, 17 disposed on the outer portions of the end caps 20, 21 and engaged with the end caps 20, 21 respectively. The end caps 20, 21 and the wipers 15, 17 may be secured to the slider 11 with such as latches or fasteners (not shown). The end caps 20, 21 each may include two or more return channels 80 (FIGS. 6, 7) aligned with and/or communicating with the grooves 12, 14 of the slider 11 for forming two or more endless ball receiving passages and for slidably receiving the balls or ball bearing device 8.

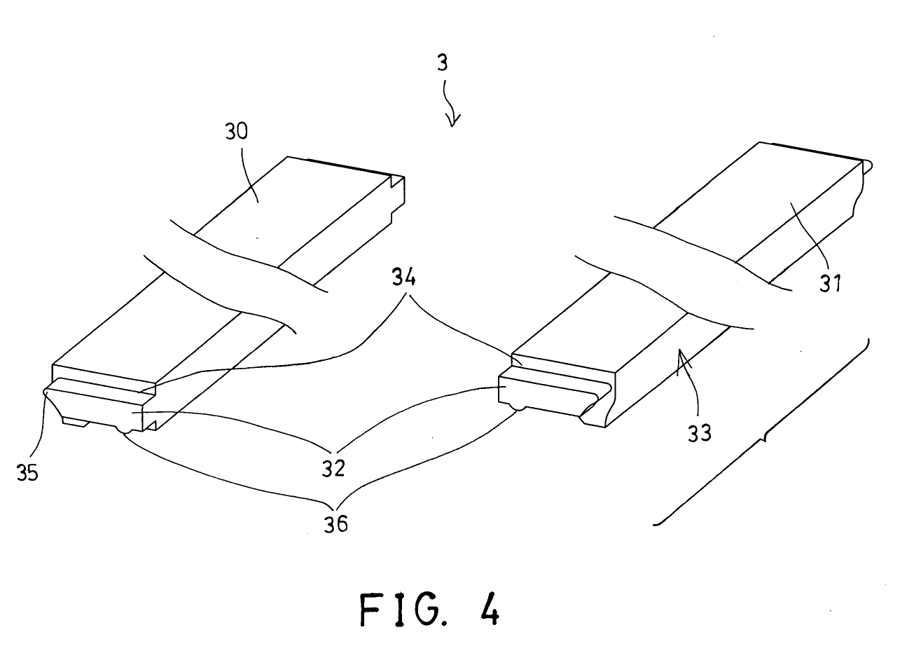

Alternatively, an end deflector 88 (FIG. 3) may be attached to each end cap 20, 21 and engaged in the return channels 80 of the end caps 20, 21 for guiding or deflecting the balls or ball bearing device 8. However, the return channels 80 of the end caps 20, 21 and/or the end deflector 88 are not related to the present invention and will not be described in further details. The end caps 20, 21 each include a peripheral frame 22 extended therefrom, such as extended from one side or inner side thereof or extended and directed or faced toward the other end cap 21, 20 for engaging with or for anchoring or supporting a ball retaining device 3 (FIGS. 3-4, 6-8) between the end caps 20, 21.

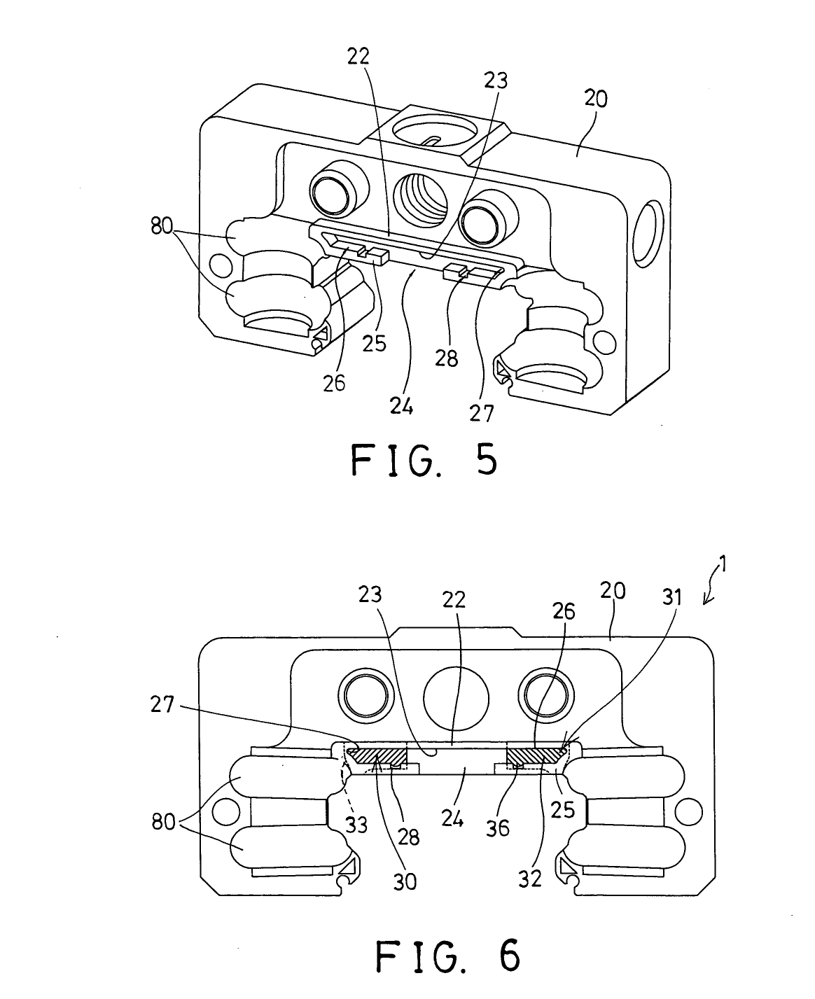

As best shown in FIGS. 3 and 5-8, the peripheral frames 22 of the end caps 20, 21 each include a longitudinal or oblong or lateral chamber 23 formed therein, and each include a notch 24 formed in the lower portion of the peripheral frame 22 and communicating with the chamber 23 of the peripheral frame 22 for forming or defining two separated but aligned arms 25, and also for forming or defining two separated spaces 26 on the side portions of the chamber 23 of the peripheral frame 22. The chamber 23 or the spaces 26 of the peripheral frame 22 each include a reduced or narrowed and/or inclined outer end portion 27 formed therein and communicating with the chamber 23 or the spaces 26 of the peripheral frame 22, and the arms 25 each include a cavity 28 formed therein and also communicating with the chamber 23 of the peripheral frame 22.

It is to be noted that the spaces 26 and the notch 24 and the chamber 23 may also be directly formed in the respective end caps 20, 21 without the peripheral frame 22 for engaging with or for receiving or supporting the ball retaining device 3. As shown in FIGS. 3-4 and 6-8, the ball retaining device 3 includes one or more (such as two) shanks 30, 31 each having an end segment 32 for engaging into the spaces 26 of the peripheral frames 22 or of the end caps 20, 21 and for attaching or coupling or securing the shanks 30, 31 to the end caps 20, 21. The shanks 30, 31 each include a curved side surface 33 for suitably or smoothly engaging with the balls or ball bearing device 8 (FIG. 2). The end segments 32 of the shanks 30, 31 include a width or length equals to or smaller or no greater than the notches 24 of the end caps 20, 21 for allowing the end segments 32 of the shanks 30, 31 to be engaged through the notches 24 and then into the spaces 26 or the chamber 23 of the peripheral frames 22 or of the end caps 20, 21.

As best shown in FIG. 2, a narrowed outer opening distance “L” will be arranged or formed between the corresponding curved side surface 33 of the shanks 30, 31 and the slider 11 and will be slightly smaller or shorter than the outer diameter “D” of the balls or ball bearing device 8 for engaging with the balls or ball bearing device 8 and for stably anchoring and retaining the balls or ball bearing device 8 in the grooves 12, 14 of the slider 11 and for preventing the balls or ball bearing device 8 from being disengaged from the grooves 12, 14 of the slider 11. It is preferable, but not necessarily that the shanks 30, 31 include an outer peripheral contour or shape equals to or corresponding to that of the peripheral frames 22 of the end caps 20, 21.

The end segments 32 of the shanks 30, 31 include a reduced or narrower outer peripheral contour or shape or thickness than that of the shanks 30, 31 for forming or defining an outer peripheral shoulder 34 between the end segments 32 and the shanks 30, 31, and the end segments 32 include an outer peripheral contour or shape equals to or corresponding to that of the spaces 26 or the chamber 23 of the peripheral frames 22 or of the end caps 20, 21 and arranged for allowing the end segments 32 of the shanks 30, 31 to be snugly fitted into or engaged in the spaces 26 or the chamber 23 of the peripheral frames 22 or of the end caps 20, 21, best shown in FIG. 6.

It is further preferable, but not necessarily that the shanks 30, 31 include a reduced or narrowed and/or inclined outer flange 35 formed or provided on each of the end segments 32 of the shanks 30, 31 and having an outer peripheral contour or shape equals to or corresponding to that of the outer end portions 27 of the spaces 26 of the peripheral frame 22 for snugly fitting into or engaging with the spaces 26 or the chamber 23 of the peripheral frames 22 or of the end caps 20, 21 and for preventing the end segments 32 of the shanks 30, 31 from being moved relative to the peripheral frames 22 or the end caps 20, 21. The end segments 32 of the shanks 30, 31 each include a catch 36 extended therefrom for engaging with or into the cavity 28 of the arms 25 or of the end caps 20, 21 and thus for detachably securing or anchoring the end segments 32 of the shanks 30, 31 to the end caps 20, 21 (FIG. 7).

It is preferable, but not necessarily that the catches 36 of the end segments 32 or of the shanks 30, 31 include a curved or rounded outer peripheral contour or shape for allowing the catches 36 of the end segments 32 or of the shanks 30, 31 to be easily engaged into or disengaged from the cavity 28 of the arms 25 or of the end caps 20, 21, and thus for allowing the shanks 30, 31 of the ball retaining device 3 to be easily and quickly and readily attached or coupled or secured to the end caps 20, 21 without distorting or deforming the configuration or the structure of the shanks 30, 31 of the ball retaining device 3. The catches 36 may thus be formed and acted as a means for catching or anchoring or positioning the end segments 32 of the shanks 30, 31 to the end caps 20, 21.

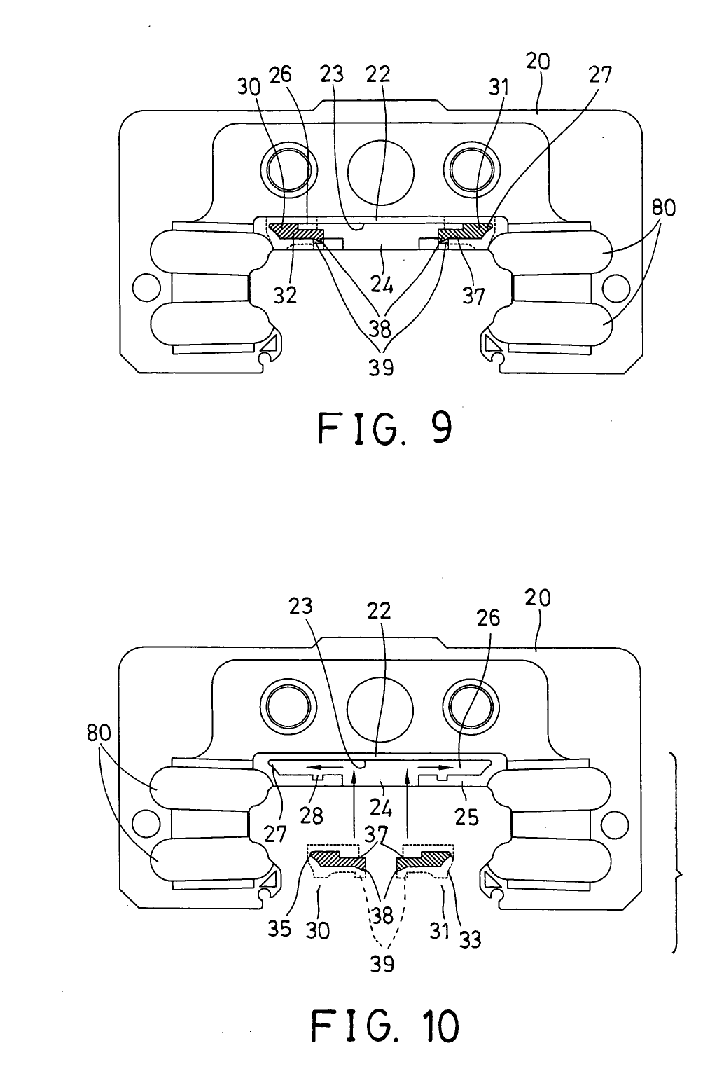

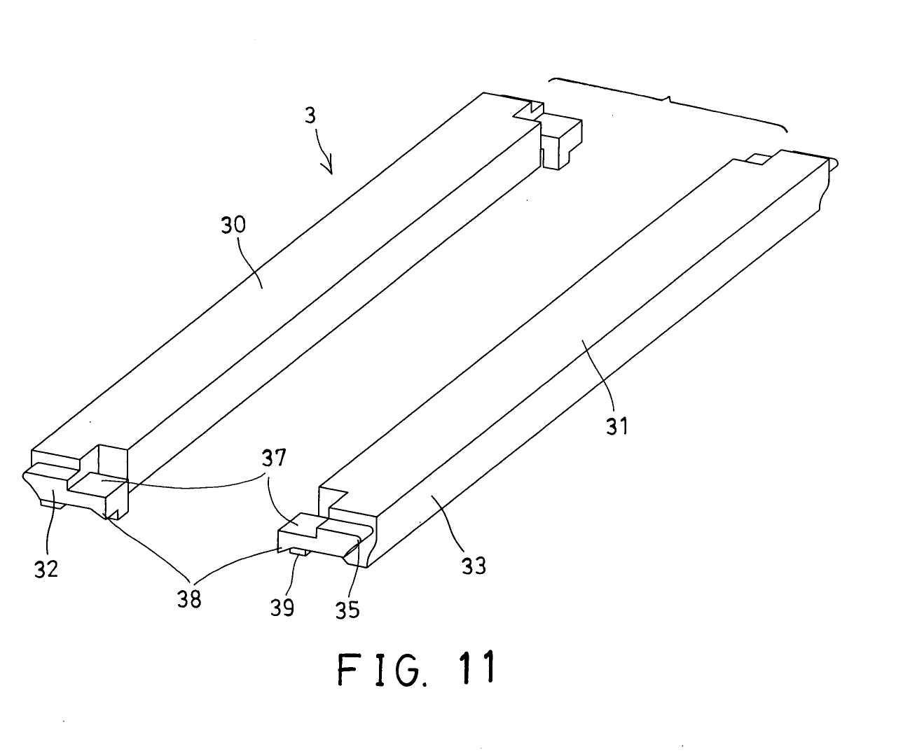

Alternatively, as shown in FIGS. 9-11, instead of the curved or rounded catches 36 of the end segments 32 or of the shanks 30, 31, the shanks 30, 31 each may include a spring leg 37 extended from each of the end segments 32 of the shanks 30, 31 and having a ratchet pawl or tooth 38 extended from the spring leg 37 for selectively or detachably engaging with or into the cavity 28 of the arms 25 or of the end caps 20, 21 (FIG. 9), and having a hand grip or knob 39 extended from the spring leg 37 for selectively disengaging the ratchet pawl or tooth 38 from the cavity 28 of the arms 25 or of the end caps 20, 21 and thus for allowing the shanks 30, 31 of the ball retaining device 3 to be detachably attached or coupled or secured to the end caps 20, 21.

In assembling the ball retaining device 3 to the slider 11 and the end caps 20, 21, as shown in FIG. 8, the end caps 20, 21 and/or the wipers 15, 17 may first be secured to the slider 11, and the slider 11 and the end caps 20, 21 and/or the wipers 15, 17 may then be rotated for about 90 degrees for allowing the balls or ball bearing device 8 to be easily engaged into the grooves 12, 14 of the slider 11. The end segments 32 or of the shanks 30, 31 may then be engaged through the notches 24 and then into the spaces 26 or the chamber 23 of the peripheral frames 22 or of the end caps 20, 21 until the catches 36 of the end segments 32 or of the shanks 30, 31 are fitted or engaged into the cavity 28 of the arms 25 or of the end caps 20, 21, in order to stably anchor and retain the balls or ball bearing device 8 in the grooves 12, 14 of the slider 11.

Accordingly, the linear motion guide apparatus in accordance with the present invention includes a ball retaining device designed and arranged to be easily and readily attached to the linear motion guide apparatus without distorting or deforming the configuration or the structure of the ball retaining device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A linear motion guide apparatus comprising:
a guide rail,
a slider slidably attached onto said guide rail for moving along said guide rail, said slider including two side grooves formed therein for slidably receiving a ball bearing device,
two end caps attached to said slider, said end caps each including a chamber formed therein, and
a ball retaining device including two shanks each having an end segment for engaging into said chambers of said end caps, said shanks being engageable with said ball bearing device for stably anchoring and retaining said ball bearing device in said grooves of said slider, and
means for anchoring said end segments of said shanks to said end caps and to detachably secure said shanks of said ball retaining device to said end caps.

2. The linear motion guide apparatus as claimed in claim 1, wherein said end caps each include a peripheral frame extended therefrom and having said chamber formed in said peripheral frame for receiving said end segments of said shanks.

3. The linear motion guide apparatus as claimed in claim 1, wherein said end caps each include a reduced end portion formed therein and communicating with said chamber of said end cap, and said end segments of said shanks each include a reduced outer flange provided thereon for engaging with said reduced end portions of said end caps.

4. The linear motion guide apparatus as claimed in claim 1, wherein said end caps each include a cavity formed therein and communicating with said chamber of said end cap, and said anchoring means includes a catch extended from each of said end segments of said shanks for engaging with said cavity of said end cap and for detachably securing said end segments of said shanks to said end caps.

5. The linear motion guide apparatus as claimed in claim 4, wherein said end caps each include a peripheral frame extended therefrom and having said chamber formed in said peripheral frame for receiving said end segments of said shanks.

6. The linear motion guide apparatus as claimed in claim 5, wherein said end caps each include a peripheral frame extended therefrom and having said chamber formed in said peripheral frame, and a notch formed in said peripheral frame and communicating with said chamber of said peripheral frame for forming two arms and two spaces in said peripheral frame.

7. The linear motion guide apparatus as claimed in claim 6, wherein said end segments of said shanks include a width no greater than said notches of said end caps for allowing said end segments of said shanks to be engaged through said notches and then into said spaces and said chamber of said peripheral frames of said end caps.

8. The linear motion guide apparatus as claimed in claim 4, wherein said catches include a rounded contour.

9. The linear motion guide apparatus as claimed in claim 1, wherein said end segments of said shanks include a narrower outer peripheral contour than that of said shanks for forming an outer peripheral shoulder between said end segment and said shank.
